(19) United States
(12) Patent Application Publication
(10) Pub. No.: US 2005/0018843 A1
(43) Pub. Date: Jan. 27, 2005

(54) Methods and systems of watermarking multimedia data using mobile communication terminals

(75) Inventor: Jin Young Park, Seoul (KR)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: PANTECH CO., LTD.

(21) Appl. No.: 10/897,710

(22) Filed: Jul. 23, 2004

(30) Foreign Application Priority Data
Jul. 24, 2003 (KR) 10-2003-0051060
Jul. 24, 2003 (KR) 10-2003-0051062
Oct. 2, 2003 (KR) 10-2003-0068733

(51) Int. Cl. H04B 7/00

(52) U.S. Cl. 380/203

(57) ABSTRACT

Disclosed are methods and systems of watermarking multimedia data using mobile communication terminals. More particularly, methods and systems of selectively watermarking the multimedia data are disclosed. According to the present invention, it is made possible to trace and check author or provider of multimedia data without intervention of a certificate authority, thereby protecting copyright of multimedia data and resolving problems misusing and abusing multimedia data relating to other person's privacy. Further, it is made possible to minimize economic loss and to prevent processing speed of mobile communication terminals from being reduced.

### CROSS-REFERENCE TO RELATED APPLICATIONS

The present application is claiming priority of Korean Patent Application Serial No. 10-2003-0051060, filed on Jul. 24, 2003, Korean Patent Application Serial No. 10-2003-0051062, filed on Jul. 24, 2003, and Korean Patent Application Serial No. 10-2003-0068733, filed on Oct. 2, 2003, the content of which is herein incorporated by reference.

### BACKGROUND OF THE INVENTION

1. Field of the Invention

The present invention relates to methods and systems of watermarking multimedia data using mobile communication terminals, and more particularly to methods and systems of selectively watermarking the multimedia data.

2. Description of the Related Art

Generally, in order to distribute multimedia data (for example, music, picture and moving picture files, etc.), information such as user information, multimedia data information and watermark information should be transmitted to a certificate authority to receive authentication from the certificate authority. Then, the multimedia data is watermarked by a watermarking tool which is provided by the certificate authority, and the watermarked multimedia data is provided to the public through mobile communication terminals or networks.

The general mobile communication terminal has been developed to increase applicability of multimedia data by using peripherals (for example, camera, camcorder, microphone and speaker, etc.), a microprocessor, a digital signal processing (DSP) processor and a moving picture experts group (MPEG) chip having enhanced operating speed and performance.

However, there are problems that multimedia data illegally copied by using such enhanced functions are distributed and multimedia data violating other person's privacy are produced by using the peripherals and commercially used.

Like these, illegal copy of multimedia data and invasion of other person's privacy happen a lot in the related art mobile communication system, so that they became big obstacles of information age.

### SUMMARY OF THE INVENTION

Accordingly, the present invention has been made to solve the above-mentioned problems occurring in the related art. The object of the present invention is to protect copyright of multimedia data and resolve problems misusing and abusing multimedia data relating to other person's privacy. Another object of the present invention is to minimize economic loss and to prevent processing speed of mobile communication terminals from being reduced.

In order to achieve at least the above objects, in whole or in parts, there is provided a system of watermarking multimedia data using mobile communication terminals, comprising: a first communication device connectable to the mobile communication terminal; and the mobile communication terminal for storing multimedia data in the mobile communication terminal, the multimedia data being received from the first communication device or being produced in the mobile communication terminal, by selectively watermarking the multimedia data through using electronic serial number (ESN) of the mobile communication terminal, or for transmitting the multimedia data to a second communication device, the multimedia data being received from the first communication device or being produced in the mobile communication terminal, by selectively watermarking the multimedia data through using the electronic serial number (ESN) of the mobile communication terminal.

According to the system of watermarking multimedia data, multimedia data edited by different communication devices can be watermarked as well as multimedia data never edited.

Preferably, the mobile communication terminal may comprise: multimedia data transceiver block for transmitting the multimedia data to the second communication device or receiving the multimedia data from the first communication device; memory for storing the multimedia data, the multimedia data being received from the first communication device or produced in the mobile communication terminal; watermark block for producing watermark by converting the ESN into binary image; and moving picture experts group (MPEG) processor for performing watermarking for the multimedia data by inserting the watermark produced in the watermark block into the multimedia data, the multimedia data being received from the first communication device or being produced in the mobile communication terminal. The multimedia data transceiver block may be provided variously in communication devices according to the present invention and function as at least one element (for example, USB block, multimedia data block, etc.) for transmitting multimedia data to at least one communication device or receiving multimedia data from at least one communication device.

Preferably, the first communication device may be at least one personal computer, base station or mobile communication terminal. In other words, the mobile communication terminal comprising the multimedia data transceiver block may receive the multimedia data from at least one personal computer, base station or other mobile communication terminal, through wired connection means such as USB cable, wireless connection means such as Bluetooth and infrared data association (IrDA) protocol, and mobile communication networks such as cellular network.

Preferably, the first communication device may be at least one personal computer or base station, comprising watermarking tool block for producing watermark by converting the ESN into binary image, the ESN being transmitted from the mobile communication terminal, and watermarking the multimedia data by using the watermark, the multimedia data being received from the mobile communication terminal.

Preferably, the second communication device may transmit the multimedia data received from the mobile communication terminal to at least one network, the multimedia data being in a watermarked state. In other words, the multimedia data received by the second communication device may be transmitted, in a watermarked state, to public telephone networks such as public switched telephone network (PSTN), wired internet networks such as local access network (LAN) or mobile communication networks such as cellular network, thereby being transmitted to other communication devices.

Preferably, the second communication device may be at least one personal computer, base station or mobile communication terminal.

Preferably, the mobile communication terminal may transmit the multimedia data to the second communication device, the multimedia data being in a watermarked state.

Preferably, the MPEG processor may insert the watermark into the multimedia data, at frequency range while performing discrete cosine transform (DCT).

Preferably, the MPEG processor may selectively insert the watermark.

Preferably, the watermark block may select a type of the watermark depending on a size of the multimedia data, and replace the ESN of the mobile communication terminal with watermark character set according to the selected type of the watermark.

Preferably, the watermarking tool block may select a type of the watermark depending on a size of the multimedia data, the multimedia data not being watermarked, and replace the ESN of the mobile communication terminal with watermark character set according to the selected type of the watermark.

Preferably, the second communication device may be at least one personal computer or base station, comprising watermarking tool block for checking whether the multimedia data is watermarked or not, the multimedia data being received from the mobile communication terminal, and watermarking the multimedia data, the multimedia data not being watermarked, by using the ESN of the mobile communication terminal.

Preferably, the watermarking tool block may select a type of the watermark depending on a size of the multimedia data, the multimedia data not being watermarked, and replace the ESN of the mobile communication terminal with watermark character set according to the selected type of the watermark.

Preferably, the watermark block may define character positions and character sets for a hexadecimal ESN, convert the hexadecimal ESN into binary image and use the converted image as watermark.

On the other hand, in order to achieve at least the above objects, in whole or in parts, there is provided a method of watermarking multimedia data using mobile communication terminals, comprising the act of transmitting multimedia data from the mobile communication terminal to a second communication device through selective watermarking by using inherent electronic serial number (ESN) of the mobile communication terminal, the multimedia data being received from a first communication device or being produced in the mobile communication, the first communication device being connectable to the mobile communication terminal.

Preferably, the method may further comprise the act of transmitting the multimedia data from the second communication device to at least one network, the multimedia data being in a watermarked state.

Preferably, the act of transmitting the multimedia data from the mobile communication terminal to the second communication device may comprise: determining whether to insert watermark into the multimedia data or not; selecting a type of the watermark depending on a size of the multimedia data, in case of determining to insert the watermark; producing the watermark by replacing the ESN of the mobile communication terminal with character set according to the selected type of the watermark; and inserting the watermark into the multimedia data, recording file information that the multimedia data is watermarked and transmitting the file information and the multimedia data to the second communication device.

Preferably, the act of transmitting the multimedia data from the mobile communication terminal to the second communication device may comprise: determining whether to insert watermark into the multimedia data or not; in case of determining not to insert the watermark, recording file information that the multimedia data is not watermarked and transmitting the file information and the multimedia data to the second communication device.

Preferably, the first communication device may be at least one personal computer, base station or mobile communication terminal.

Preferably, the second communication device may be at least one personal computer, base station or mobile communication terminal.

Preferably, the act of transmitting the multimedia data from the second communication device to network may comprise: checking whether the multimedia data is watermarked or not, the multimedia data being received from the mobile communication terminal; inserting watermark into the multimedia data, in case that the multimedia data is not watermarked; and transmitting the multimedia data to the network, the multimedia data being watermarked.

Preferably, said inserting the watermark into the multimedia data may comprise: selecting a type of the watermark depending on a size of the multimedia data; producing the watermark by replacing the ESN of the mobile communication terminal with watermark character set according to the selected type of the watermark; and inserting the watermark into the multimedia data.

On the other hand, in order to achieve at least the above objects, in whole or in parts, there is provided a mobile communication terminal, wherein the mobile communication terminal may store multimedia data in memory of the mobile communication terminal or transmits the multimedia data to a second communication device, the multimedia data being received from a first communication device or being produced in the mobile communication terminal, and selectively perform watermarking for the multimedia data by using inherent electronic serial number (ESN) of the mobile communication terminal when storing the multimedia data in the memory or transmitting the multimedia data to the second communication device.

Preferably, the mobile communication terminal may comprise: multimedia data transceiver block for transmitting the multimedia data to the second communication device or receiving the multimedia data from the first communication device; the memory for storing the multimedia data, the multimedia data being received from the first communication device or produced in the mobile communication terminal; watermark block for producing watermark by converting the inherent ESN into binary image; and moving picture experts group (MPEG) processor for performing watermarking for the multimedia data by inserting the watermark produced in the watermark block into the multimedia data, the multimedia data being received from the first communication device or being produced in the mobile communication terminal.

Preferably, the first communication device may be at least one personal computer, base station or mobile communication terminal.

Preferably, the second communication device may be at least one personal computer, base station or mobile communication terminal.

Preferably, the mobile communication terminal may transmit the multimedia data to the second communication device, the multimedia data being in a watermarked state.

Preferably, the watermark block may select a type of the watermark depending on a size of the multimedia data, the multimedia data not being watermarked, and replace the ESN of the mobile communication terminal with watermark character set according to the selected type of the watermark.

Preferably, the MPEG processor may insert the watermark into the multimedia data, at frequency range while performing discrete cosine transform (DCT).

Preferably, the MPEG processor may selectively insert the watermark.

Preferably, the watermark block may define character positions and character sets for a hexadecimal ESN, convert the hexadecimal ESN into binary image and use the converted image as watermark.

On the other hand, in order to achieve at least the above objects, in whole or in parts, there is provided a method of watermarking multimedia data using mobile communication terminals, comprising the act of storing multimedia data in memory of the mobile communication terminal by selectively watermarking the multimedia data through using inherent electronic serial number (ESN) of the mobile communication terminal, the multimedia data being received from a first communication device or being produced in the mobile communication terminal, the first communication device being connectable to the mobile communication terminal.

Preferably, the act of storing the multimedia data in the memory of the mobile communication terminal may comprise: determining whether to insert watermark into the multimedia data or not; selecting a type of the watermark depending on a size of the multimedia data, in case of determining to insert the watermark; producing the watermark by replacing the ESN of the mobile communication terminal with character set according to the selected type of the watermark; and inserting the watermark into the multimedia data, recording file information that the multimedia data is watermarked and storing the file information and the multimedia data in the memory of the mobile communication terminal.

Preferably, the act of storing the multimedia data in the memory of the mobile communication terminal may comprise: determining whether to insert watermark into the multimedia data or not; and in case of determining not to insert the watermark, recording file information that the multimedia data is not watermarked and storing the file information and the multimedia data in the memory of the mobile communication terminal.

Preferably, the method may further comprise the act of transmitting the multimedia data from the memory of the mobile communication terminal to a second communication device, the multimedia data being in a watermarked state.

Preferably, the first communication terminal may be at least one personal computer, base station or mobile communication terminal.

Preferably, the second communication terminal may be at least one personal computer, base station or mobile communication terminal.

Preferably, the act of transmitting the multimedia data from the memory of the mobile communication terminal to the second communication device may comprise: checking whether the multimedia data is watermarked or not; inserting watermark into the multimedia data, in case that the multimedia data is not watermarked; and transmitting the multimedia data to the second communication device, the multimedia data being watermarked.

Preferably, said inserting the watermark into the multimedia data may comprise: selecting a type of the watermark depending on a size of the multimedia data; producing the watermark by replacing the ESN of the mobile communication terminal with a watermark character set according to the selected type of the watermark; and inserting the watermark into the multimedia data and recording file information that the multimedia data is watermarked.

Preferably, said transmitting the multimedia data to the second communication device may comprise transmitting the file information to the second communication device.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing construction of a system of watermarking multimedia data according to a preferred embodiment of the present invention;

FIGS. 2 and 3 illustratively show patterns of a binary image to be used as a watermark in FIG. 1;

FIGS. 4 and 5 illustrate character sets for an Electronic Serial Number (ESN) in FIG. 1;

FIG. 6 is a flowchart showing a multimedia data watermarking process in a mobile communication terminal according to a preferred embodiment of the present invention;

FIG. 7 is a flowchart showing a multimedia data watermarking process in a base station according to a preferred embodiment of the present invention.

### DETAILED DESCRIPTION OF THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

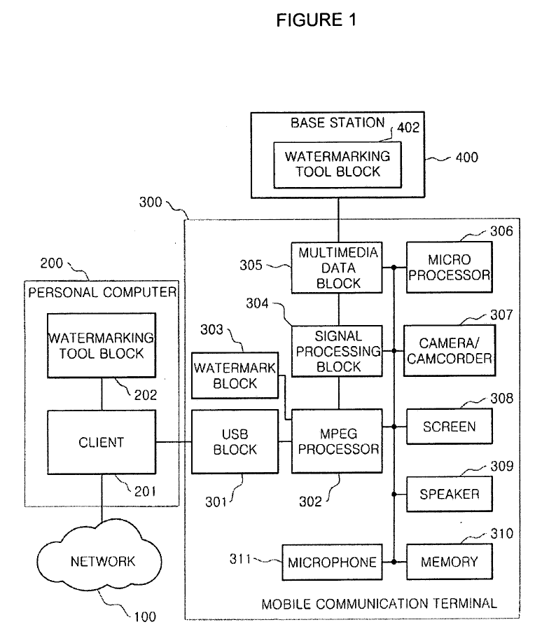

Referring to FIG. 1, a system of watermarking multimedia data according to the present invention comprises a network 100, a personal computer 200, a mobile communication terminal 300 and a base station 400.

The mobile communication terminal 300 is connected to the personal computer 200 and the base station 400 so as to transmit/receive data in a wired and wireless manner, and the personal computer 200 may share data via the network 100.

The personal computer 200 transmits all multimedia data transmitted from the network 100 to the mobile communication terminal 300. The personal computer 200 receives an electronic serial number (ESN) from the mobile communication terminal 300 and converts the ESN into a binary image, thereby performing a watermarking process by using the binary image as a watermark.

The personal computer 200 comprises: a client 201 for communicating with the network 100 and the mobile communication terminal 300; and a watermarking tool block 202 for converting the ESN transmitted through the client 201 into the binary image to watermark multimedia data by using the converted image as a watermark.

The mobile communication terminal 300 receives multimedia data from the personal computer 200 or the base station 400 or produces multimedia data with various peripherals. Then, the mobile communication terminal 300 inserts a watermark into the received or produced multimedia data and stores the watermarked data in the mobile communication terminal. Differently, the mobile communication terminal 300 may insert the watermark when transmitting the multimedia data and transmit its own ESN to the personal computer 200 when receiving an ESN transmission request from the personal computer 200 that received the multimedia data from the mobile communication terminal 300. As described above, the mobile communication terminal 300 may store the multimedia data first and transmit the multimedia data to other communication devices such as the personal computer 200. On the other hand, according to another system of watermarking multimedia data according to the present invention, multimedia data may be transmitted from mobile communication terminal to a second communication device such as at least one personal computer, base station and other mobile communication terminal, without storing the multimedia data in the mobile communication terminal, by selectively watermarking the multimedia data, the multimedia data being produced in the mobile communication terminal or being received from a first communication device such as at least one personal computer, base station and other mobile communication terminal.

According to the present invention, the first communication device may be the same communication device as the second communication device. On the other hand, the first communication device may be not the same communication device as the second communication device. Further, between the mobile communication terminal and the first communication terminal, and between the mobile communication terminal and the second communication terminal, the multimedia data may be transmitted through wired connection means such as USB cable, wireless connection means such as Bluetooth, IrDA protocol, etc., and mobile communication networks such as cellular network. The present invention is not limited to the connection means illustrated in the FIG. 1. On the other hand, the mobile communication terminal 300 comprises a universal serial bus (USB) block 301 for performing a serial communication with the personal computer 200, a moving picture experts group (MPEG) processor 302 for encoding, decoding and watermarking data, a watermark block 303 for producing a watermark, a signal processing block 304 for digital signal processing, a multimedia data block 305 for transmitting the multimedia data to the base station 400 and receiving the multimedia data from the base station 400, a microprocessor 306 for operating and controlling a baseband system, a memory 310 for storing data and peripherals such as a camera/camcorder 307, a screen 308 and a speaker 309. The USB block 301 and the multimedia data block 305 illustrated in the FIG. 1 function as multimedia data transceiver block for transmitting multimedia data between the mobile communication terminal and the first communication device and between the mobile communication terminal and the second communication device. Particularly, the USB block 301 functions for multimedia data transmission between the mobile communication terminal and the personal computer and the multimedia data block 305 functions for multimedia data transmission between the mobile communication terminal and the base station.

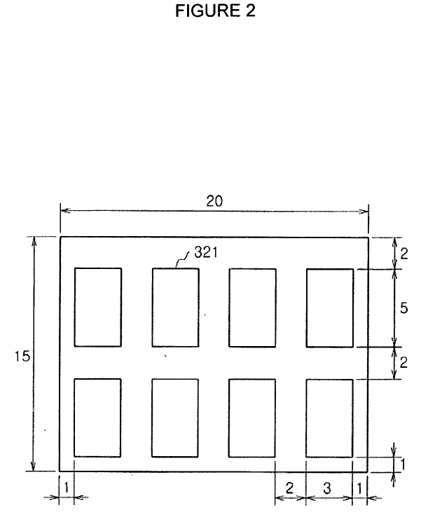

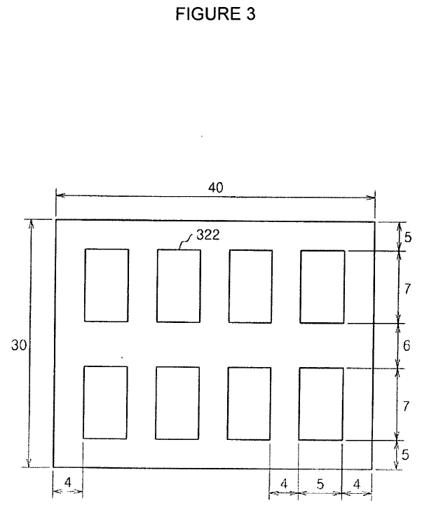

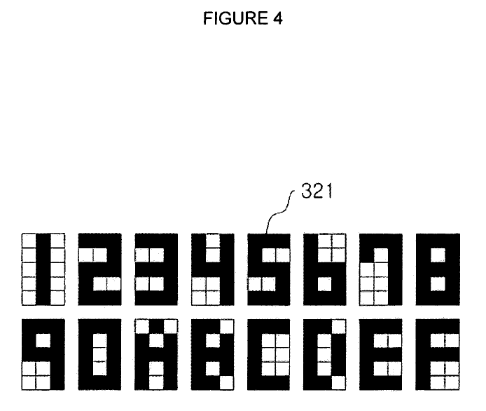

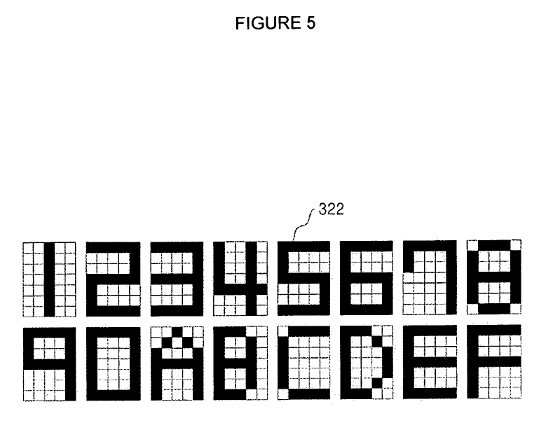

The MPEG processor 302 selectively inserts the watermark, produced by the watermark block 303, into the multimedia data, received through the USB block 301 or produced in the peripherals, at frequency range while performing discrete cosine transform (DCT), and selectively inserts the watermark into the multimedia data when transmitting the multimedia data. The watermark block 303 converts a hexadecimal ESN into a binary image, and defines character positions of the ESN as patterns shown in FIGS. 2 and 3 and character sets as patterns shown in FIGS. 4 and 5.

The watermark used in watermarking multimedia data is binary image having patterns as shown in FIGS. 2 and 3 inserted into the multimedia data. The hexadecimal character of the ESN as a watermark is converted into a binary image having patterns as shown in FIGS. 4 and 5 and used during watermarking. The binary image has a size, for example, as shown in FIG. 2 or 3.

The base station 400 comprises a watermarking tool block 402. The base station receives multimedia data from the mobile communication terminal 300 and transmits the multimedia data to a mobile communication network. At this time, the base station 400 checks whether a watermark is embedded into the multimedia data by checking file information of the multimedia data and the watermarking tool block 402 of the base station 402 watermarks the multimedia data by using the ESN of the mobile communication terminal 300 that transmits the multimedia data to the base station, in case that the multimedia data is not watermarked.

The watermarking tool block 402 converts the ESN of the mobile communication terminal 300 into a binary image and watermarks multimedia data by using the image as a watermark.

According to the method of watermarking the multimedia data using the mobile communication terminal of the present invention, there are four modes of inserting a watermark into multimedia data (for example, picture file, moving picture file, sound file, etc.) by using the mobile communication terminal.

In a first mode, a watermark is inserted into multimedia data received from the first communication device such as the personal computer or the base station while the multimedia data is stored in the memory of the mobile communication terminal.

In a second mode, a watermark is inserted into multimedia data while the mobile communication terminal transmits the multimedia data to the base station.

In a third mode, a watermark is inserted into multimedia data produced in the mobile communication while the multimedia data is stored in the memory of the mobile communication terminal.

In a fourth mode, the second communication device (e.g. the personal computer and the base station), that received multimedia data from the mobile communication terminal, produces a watermark through watermarking means such as watermarking tool block by converting ESN of the mobile communication terminal into binary image and inserts the watermark into the multimedia data.

Preferably, the second communication device such as the personal computer and the base station performs watermarking for the multimedia data, after receiving the ESN of the mobile communication terminal from the mobile communication terminal.

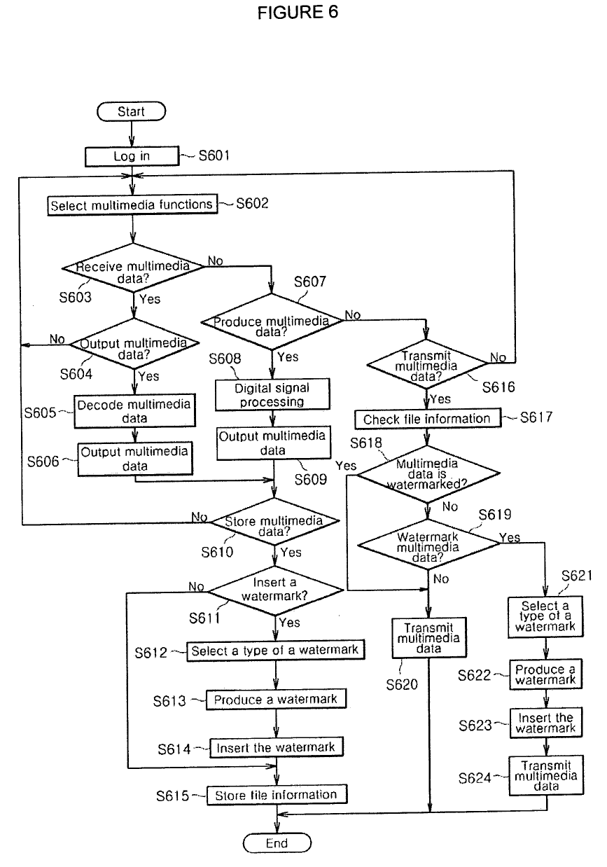

FIG. 6 is a flowchart showing a multimedia data watermarking process in the mobile communication terminal 300 according to the present invention.

Referring to FIG. 6, an user of the mobile communication terminal logs in by inputting a password through a keypad of the mobile communication terminal (S601). Under such a state, watermarking process can be performed by detecting selection of multimedia functions (S602).

Whether to receive multimedia data from the personal computer or the base station is checked (S603). When reception of multimedia data is selected, watermarking process can be selectively performed to prevent multimedia data from being illegally copied and distributed after the multimedia data is received.

Then, whether to output the multimedia data is checked (S604). The multimedia data is encoded data in the type of MPEG.

Accordingly, when the multimedia data is outputted, the multimedia data is decoded by the MPEG processor 302 (S605) and the decoded multimedia data is outputted through screen 308 and speaker 309 (S606).

On the other hand, in case of determining not to receive multimedia data from the personal computer or the base station, whether to produce multimedia data in the mobile communication terminal by using peripherals (e.g. camera/camcorder 307, microphone 311) is checked (S607).

When production of multimedia data is selected, watermarking process can be selectively performed to prevent multimedia data from being illegally copied and distributed after the multimedia data is produced.

As a result of that, the signal processing block 304 performs a digital signal processing (for example, a data format transformation) of the produced multimedia data (S608), and then outputs the digitally signal processed multimedia data through the screen 308 and the speaker 309 (S609).

At the same time, whether the multimedia data decoded in the step S605 or the multimedia data digitally signal processed in the step S608 is stored or not is determined (S610). Then, in case of storing the multimedia data, whether to insert a watermark or not is determined (S611).

That is, whether to insert a watermark can be previously set by user and can be selectively performed, so that unnecessary operation can be minimized by omitting watermarking process of multimedia that does not need to be watermarked.

If it is previously set by user that the watermark should be inserted, a type of a watermark is selected depending on a size of the multimedia data to be watermarked (S612).

Then, the ESN of the mobile communication terminal 300 is replaced with character sets as shown in FIG. 4 or 5 according to the selected type of the watermark, thereby producing a watermark for tracing an illegal user of multimedia data (S613).

The watermark is produced in the watermark block 303 by using a unique ESN of the mobile communication terminal 300.

The watermark block 303 can convert a hexadecimal ESN into a binary and use the converted binary as a watermark. When watermarked data is subject to a variety of digital signal processing (e.g. filtering, size conversion, compression ratio conversion, etc.) in the signal processing block 304, a part of the inserted watermark can be damaged. Thus, since exact user information cannot be extracted, the watermark block 303 converts the hexadecimal ESN into a binary image.

At this time, the binary image is defined as two patterns classified into, for example, a pattern of 15*20 pixels 321 as shown in FIG. 2 and a pattern of 30*40 pixels 322 as shown in FIG. 3, for the purpose of selectively applying a watermark depending on a size of multimedia data to be watermarked.

When a size of multimedia data to be watermarked is large, an invisibility of the watermarking is satisfied since a distorted part of watermarked data cannot be visually distinguished compared to an original data, even if the watermark is inserted.

However, when a size of multimedia data is small, i.e., a watermark having a relatively large size is inserted into multimedia data having a small size, many distortions occur in the watermarked data. Thus, the watermarked data is no longer meaningful as multimedia data. Further, invisibility of a watermark is not satisfied, so that the watermark is easily to be eliminated by an illegal user. Accordingly, it is important to select a type of a watermark depending on a size of multimedia data to be watermarked.

For example, when a size of an original data is equal to or larger than a VGA size (for example, 640*480 pixels), a file size as shown in FIG. 3 is desirable to be used. When it is smaller than the VGA size, a file size as shown in FIG. 2 is desirable to be used.

When the digital signal processing is applied to the watermarked data in the signal-processing block 304, slight data loss occurs in the extracted watermark, thereby decreasing identity of the ESN. Accordingly, in order to increase a corrective ability and identity of the extracted watermark, character positions of the ESN are defined as patterns as shown in FIGS. 2 and 3. In addition, the hexadecimal ESN is defined as character sets as patterns as shown in FIGS. 4 and 5, wherein pixel number of each of characters is 5*3 pixels 321 and 7*5 pixels 322 and selected depending on the size of the original data.

And then, the watermark produced in the step S613 is inserted by an encoder of the MPEG processor 302. That is, the MPEG processor 302 inserts a watermark at frequency range while performing the DCT (S614).

When it is previously set by user that a watermark is not inserted in the step S611, or after inserting the watermark in the step S614, file information is stored. At this time, a file name and whether a watermark is inserted or not are recorded and stored (S615). The file information is used to identify whether a watermark is embedded or not when transmitting multimedia data to the base station (S617).

When it is determined that multimedia data is watermarked (i.e. a watermark is embedded into the multimedia data) (S618), multimedia data file comprising the multimedia data and the file information is transmitted to the base station (S620). On the other hand, when it is determined that multimedia data is not watermarked, whether to insert a watermark into the multimedia data or not is checked (S619).

As a result of the check, when it is previously set not to insert a watermark, multimedia data file comprising multimedia data and the file information is transmitted to the base station. On the other hand, when it is previously set to insert a watermark, a type of watermark is selected depending on the size of the multimedia data (S621).

Then, the ESN of the mobile communication terminal 300 is replaced with watermark character sets as shown in FIG. 4 or 5 according to the selected type of the watermark, so that a watermark for tracing an illegal user of multimedia data is produced (S622).

After that, the produced watermark is inserted by the encoder of the MPEG processor 302. That is, the MPEG processor 302 inserts a watermark at frequency range while performing the DCT (S623), and then transmits the watermarked multimedia data file comprising multimedia data and file information (S624).

According to the above description regarding the FIG. 6, the multimedia data received from the personal computer or produced in the mobile communication terminal is stored in the mobile communication terminal. However, the present invention is not limited to the act of storing the multimedia data in the mobile communication terminal and the multimedia data may be transmitted to a second communication device without storing the multimedia data in the mobile communication terminal, according to another method of watermarking multimedia data of the present invention.

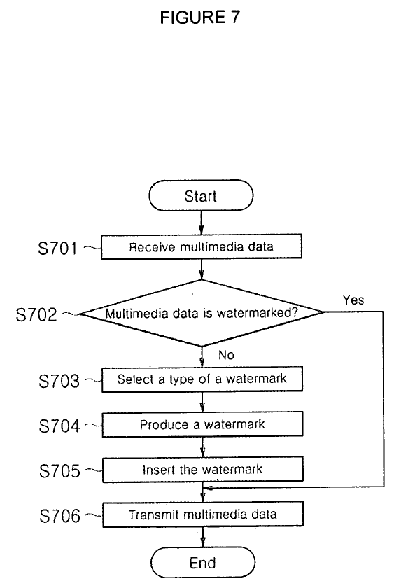

FIG. 7 is a flowchart showing a process of watermarking multimedia data in the base station 400 according to a preferred embodiment of the present invention.

Referring to FIG. 7, when the base station 400 receives multimedia data file comprising multimedia data and file information transmitted from the mobile communication terminal 300 (S701), whether the multimedia data is watermarked or not is checked by checking the file information of the received multimedia data file (S702).

As a result of the check, when the multimedia data is watermarked, the multimedia data file is transmitted to the mobile communication network, as it is (S706).

However, when the multimedia data file is not watermarked, a watermarking process is unconditionally performed by using ESN of the mobile communication terminal to protect copyright and to resolve problems abusing and misusing multimedia data relating to other person's privacy.

Accordingly, the watermarking tool block 402 selects a type of a watermark depending on a size of multimedia data to watermark the multimedia data (S703).

Then, the ESN of the mobile communication terminal 300 is replaced with watermark character sets as shown in FIG. 4 or 5 according to the selected type of the watermark, thereby producing a watermark (S704).

Then, the produced watermark is inserted into the multimedia data (S705), and the multimedia data is transmitted to the mobile communication network (S706).

FIG. 7 illustrates that the multimedia data, transmitted from the second communication device such as the base station to the networks such as the mobile communication network, should be transmitted in a watermarked state.

Meanwhile, the watermarking algorithm according to the present invention is not limited to the above embodiments, and various algorithms can be used.

On the other hand, in order to extract the watermark from watermarked multimedia data, the watermarking process according to the preferred embodiment of the present invention is inversely performed. That is, an inverse watermarking algorithm is performed to extract the watermark.

And, after extracting the watermark through the inverse watermarking algorithm, whether or not watermarking is normally performed by comparing the watermark and ESN.

As described above, according to the present invention, multimedia data can be selectively watermarked in a mobile communication terminal, a personal computer or a base station of mobile communication network by using inherent ESN of the mobile communication terminal as a watermark. Thus, it is made possible to trace and check author or provider of multimedia data without intervention of a certificate authority, thereby protecting copyright of multimedia data and resolving problems misusing and abusing multimedia data relating to other person's privacy. Further, it is made possible to minimize economic loss and to prevent processing speed of mobile communication terminals from being reduced.

The foregoing embodiments are merely exemplary and are not to be construed as limiting the present invention. Many alternatives, modifications and variations will be apparent to those skilled in the art.

1. A system of watermarking multimedia data using mobile communication terminals, comprising:
a first communication device connectable to the mobile communication terminal; and
the mobile communication terminal for storing multimedia data in the mobile communication terminal, the multimedia data being received from the first communication device or being produced in the mobile communication terminal, by selectively watermarking the multimedia data through using electronic serial number (ESN) of the mobile communication terminal, or for transmitting the multimedia data to a second communication device, the multimedia data being received from the first communication device or being produced in the mobile communication terminal, by selectively watermarking the multimedia data through using the electronic serial number (ESN) of the mobile communication terminal.

2. The system according to claim 1, wherein the mobile communication terminal comprises:
multimedia data transceiver block for transmitting the multimedia data to the second communication device or receiving the multimedia data from the first communication device;
memory for storing the multimedia data, the multimedia data being received from the first communication device or produced in the mobile communication terminal;
watermark block for producing watermark by converting the ESN into binary image; and
moving picture experts group (MPEG) processor for watermarking the multimedia data by inserting the watermark produced in the watermark block into the multimedia data, the multimedia data being received from the first communication device or being produced in the mobile communication terminal.

3. The system according to claim 1, wherein the first communication device is at least one selected from a group consisting of personal computers, base stations and mobile communication terminals.

4. The system according to claim 1, wherein the first communication device comprises watermarking tool block for producing watermark by converting the ESN into binary image, the ESN being transmitted from the mobile communication terminal, and for watermarking the multimedia data by using the watermark, the multimedia data being received from the mobile communication terminal.

5. The system according to claim 1, wherein the second communication device transmits the multimedia data received from the mobile communication terminal to at least one network, the multimedia data being in a watermarked state.

6. The system according to claim 1, wherein the second communication device is at least one selected from a group consisting of personal computers, base stations and mobile communication terminals.

7. The system according to claim 1, wherein the mobile communication terminal transmits the multimedia data to the second communication device, the multimedia data being in a watermarked state.

8. The system according to claim 2, wherein the MPEG processor inserts the watermark into the multimedia data, at frequency range while performing discrete cosine transform (DCT).

9. The system according to claim 2, wherein the MPEG processor selectively inserts the watermark.

10. The system according to claim 2, wherein the watermark block selects a type of the watermark depending on a size of the multimedia data, and replaces the ESN of the mobile communication terminal with watermark character set according to the selected type of the watermark.

11. The system according to claim 4, wherein the watermarking tool block selects a type of the watermark depending on a size of the multimedia data, the multimedia data not being watermarked, and replaces the ESN of the mobile communication terminal with watermark character set according to the selected type of the watermark.

12. The system according to claim 5, wherein the second communication device comprises watermarking tool block for checking whether the multimedia data is watermarked or not, the multimedia data being received from the mobile communication terminal, and for watermarking the multimedia data, the multimedia data not being watermarked, by using the ESN of the mobile communication terminal.

13. The system according to claim 12, wherein the watermarking tool block selects a type of the watermark depending on a size of the multimedia data, the multimedia data not being watermarked, and replaces the ESN of the mobile communication terminal with watermark character set according to the selected type of the watermark.

14. The system according to claim 10, wherein the watermark block defines character positions and character sets for a hexadecimal ESN, converts the hexadecimal ESN into binary image and uses the converted image as watermark.

15. A method of watermarking multimedia data using mobile communication terminals, comprising the act of:
transmitting multimedia data from the mobile communication terminal to a second communication device through selective watermarking by using electronic serial number (ESN) of the mobile communication terminal, the multimedia data being received from a first communication device or being produced in the mobile communication, the first communication device being connectable to the mobile communication terminal.

16. The method according to claim 15, further comprising the act of transmitting the multimedia data from the second communication device to at least one network, the multimedia data being in a watermarked state.

17. The method according to claim 15, wherein the act of transmitting the multimedia data from the mobile communication terminal to the second communication device comprises:
determining whether to insert watermark into the multimedia data or not;
selecting a type of the watermark depending on a size of the multimedia data, in case of determining to insert the watermark;
producing the watermark by replacing the ESN of the mobile communication terminal with character set according to the selected type of the watermark; and
inserting the watermark into the multimedia data, recording file information that the multimedia data is watermarked and transmitting the file information and the multimedia data to the second communication device.

18. The method according to claim 15, wherein the act of transmitting the multimedia data from the mobile communication terminal to the second communication device comprises:
determining whether to insert watermark into the multimedia data or not;
in case of determining not to insert the watermark, recording file information that the multimedia data is not watermarked and transmitting the file information and the multimedia data to the second communication device.

19. The method according to claim 15, wherein the first communication device is at least one selected from a group consisting of personal computers, base stations and mobile communication terminals.

20. The method according to claim 15, wherein the second communication device is at least one selected from a group consisting of personal computers, base stations and mobile communication terminals.

21. The method according to claim 16, wherein the act of transmitting the multimedia data from the second communication device to the network comprises:
checking whether the multimedia data is watermarked or not, the multimedia data being received from the mobile communication terminal;
inserting watermark into the multimedia data, in case that the multimedia data is not watermarked; and
transmitting the multimedia data to the network, the multimedia data being watermarked.

22. The method according to claim 21, wherein said inserting the watermark into the multimedia data comprises:
selecting a type of the watermark depending on a size of the multimedia data;
producing the watermark by replacing the ESN of the mobile communication terminal with watermark character set according to the selected type of the watermark; and
inserting the watermark into the multimedia data.

23. A mobile communication terminal, wherein the mobile communication terminal stores multimedia data in memory of the mobile communication terminal or transmits the multimedia data to a second communication device, the multimedia data being received from a first communication device or being produced in the mobile communication terminal, and selectively watermarks for the multimedia data by using electronic serial number (ESN) of the mobile communication terminal when storing the multimedia data in the memory or transmitting the multimedia data to the second communication device.

24. The mobile communication terminal according to claim 23, comprising:
multimedia data transceiver block for transmitting the multimedia data to the second communication device or receiving the multimedia data from the first communication device;
the memory for storing the multimedia data, the multimedia data being received from the first communication device or produced in the mobile communication terminal;
watermark block for producing watermark by converting the ESN into binary image; and
moving picture experts group (MPEG) processor for watermarking the multimedia data by inserting the watermark produced in the watermark block into the multimedia data, the multimedia data being received from the first communication device or being produced in the mobile communication terminal.

25. The mobile communication terminal according to claim 23, wherein the first communication device is at least one selected from a group consisting of personal computers, base stations and mobile communication terminals.

26. The mobile communication terminal according to claim 23, wherein the second communication device is at least one selected from a group consisting of personal computers, base stations and mobile communication terminals.

27. The mobile communication terminal according to claim 23, wherein the mobile communication terminal transmits the multimedia data to the second communication device, the multimedia data being in a watermarked state.

28. The mobile communication terminal according to claim 24, wherein the watermark block selects a type of the watermark depending on a size of the multimedia data, the multimedia data not being watermarked, and replaces the ESN of the mobile communication terminal with watermark character set according to the selected type of the watermark.

29. The mobile communication terminal according to claim 24, wherein the MPEG processor inserts the watermark into the multimedia data, at frequency range while performing discrete cosine transform (DCT).

30. The mobile communication terminal according to claim 24, wherein the MPEG processor selectively inserts the watermark.

31. The mobile communication terminal according to claim 28, wherein the watermark block defines character positions and character sets for a hexadecimal ESN, converts the hexadecimal ESN into binary image and uses the converted image as watermark.

32. A method of watermarking multimedia data using mobile communication terminals, comprising the act of: storing multimedia data in memory of the mobile communication terminal by selectively watermarking the multimedia data through using electronic serial number (ESN) of the mobile communication terminal, the multimedia data being received from a first communication device or being produced in the mobile communication terminal, the first communication device being connectable to the mobile communication terminal.

33. The method according to claim 32, wherein the act of storing the multimedia data in the memory of the mobile communication terminal comprises:
determining whether to insert watermark into the multimedia data or not;
selecting a type of the watermark depending on a size of the multimedia data, in case of determining to insert the watermark;
producing the watermark by replacing the ESN of the mobile communication terminal with character set according to the selected type of the watermark; and
inserting the watermark into the multimedia data, recording file information that the multimedia data is watermarked and storing the file information and the multimedia data in the memory of the mobile communication terminal.

34. The method according to claim 32, wherein the act of storing the multimedia data in the memory of the mobile communication terminal comprises:
determining whether to insert watermark into the multimedia data or not; and
in case of determining not to insert the watermark, recording file information that the multimedia data is not watermarked and storing the file information and the multimedia data in the memory of the mobile communication terminal.

35. The method according to claim 32, further comprising the act of transmitting the multimedia data from the memory of the mobile communication terminal to a second communication device, the multimedia data being in a watermarked state.

36. The method according to claim 32, wherein the first communication terminal is at least one selected from a group consisting of personal computers, base stations and mobile communication terminals.

37. The method according to claim 32, wherein the second communication terminal is at least one selected from a group consisting of personal computers, base stations and mobile communication terminals.

38. The method according to claim 35, wherein the act of transmitting the multimedia data from the memory of the mobile communication terminal to the second communication device comprises:
checking whether the multimedia data is watermarked or not;
inserting watermark into the multimedia data, in case that the multimedia data is not watermarked; and
transmitting the multimedia data to the second communication device, the multimedia data being watermarked.

39. The method according to claim 38, wherein said inserting the watermark into the multimedia data comprises:
selecting a type of the watermark depending on a size of the multimedia data;
producing the watermark by replacing the ESN of the mobile communication terminal with a watermark character set according to the selected type of the watermark; and
inserting the watermark into the multimedia data and recording file information that the multimedia data is watermarked.

40. The method according to claim 39, wherein said transmitting the multimedia data to the second communication device comprises transmitting the file information to the second communication device.
